(19) United States
(12) Patent Application Publication
(10) Pub. No.: US 2012/0030150 A1
(43) Pub. Date: Feb. 2, 2012

(54) Hybrid Learning Component for Link State Routing Protocols

(75) Inventors: Anthony McAuley, Glen Ridge, NJ (US); Latha Kant, Basking Ridge, NJ (US); Kaustubh Sinkar, New Brunswick, NJ (US)

(73) Assignee: TELCORDIA TECHNOLOGIES, INC., Piscataway, NJ (US)

(21) Appl. No.: 12/845,895

(22) Filed: Jul. 29, 2010

(51) Int. Cl. G06F 15/173; G06F 15/18

(52) U.S. Cl. 706/12; 709/241

(57) ABSTRACT

In a network that executes a link state routing protocol, a network node receives periodic disseminations of link state information from other network nodes. The link state information includes neighboring node identity and link cost metrics. The network node calculates the initial routing paths based on the received link state information by using a link state routing algorithm. It then adapts the calculated path based on both the current link state information and past link state information through a reinforcement learning process. The network node then selects a routing path to each destination node based on the adaptation and updates the routing table accordingly.

### BACKGROUND OF THE INVENTION

1. Field of the Invention

The present invention relates generally to adaptive routing systems and methods, as well as link state routing systems and methods. More particularly, the present invention relates to building an independent cognitive learning component into a link state routing protocol.

2. Description of Related Art

Distance-vector and link-state routing protocols are two major classes of distributed routing protocols. Both classes are interior gateway protocols which operate within a routing domain or an autonomous system. Networks nodes such as computers are coupled together by intra-domain routers running on various types of routing protocols.

Distance-vector routing protocols base the routing decisions on the best path to a given destination node on the distance to the destination. The distance may be measured in number of hops, or delay time, or packets lost, etc. Each router that operates using a distance-vector stores a routing table that contains the distance of the router to other routers. Each router advertises its routing table to directly connected neighbors and receives similar advertisements from the neighbors. The received distances are used by each router to update its respective routing table. The advertisement cycle continues until each router converges to stable values. Distance-vector routing protocols typically adopt the Bellman-Ford algorithm.

Unlike routers that use a distance-vector routing protocol, routers that use a link-state routing protocol possess information about the full network topology. Examples of link state routing protocols (LSRPs) include Open Shortest Path First (OSPF) and Intermediate System-to-Intermediate System (IS-IS) protocols. Each routing node (link state enabled router) that uses a link state protocol maintains a link state database (LSDB) that stores link state information, which is a tree like image of the entire network topology. Routing nodes run a flooding algorithm that periodically floods its neighboring nodes with information about its directly connected links. A typical flooding algorithm allows a routing node to send information to all the other routing nodes in the same routing domain other than the ones over which the new piece of information was received. Each node receiving the new information then updates its respective link state database with the new information. The flooding algorithm ensures that all routers within a routing domain converge on the same topological information within a finite period of time.

Nodes that use a link state routing protocol independently calculate the best next hop for every possible destination in the network using the link-state information. The collection of the best next hops forms a routing table for the respective router. The Djikstra algorithm is often adopted in link state routing protocols to obtain the best path by finding the shortest route through a network from the source to the destination node. In the Djikstra algorithm, the length of an individual link in the path is described by a cost, which could be assigned by a network management system. The length, or the total cost, of the path is then defined as the sum of this cost over all of the links that make up the path.

Link state routing protocols can provide fast convergence after a link failure and low delay at low load by using minimum hop paths. However, while giving high performance at low load, link state protocols often waste network capacity by forcing all routes to follow the shortest path. With limited capacity, most networks cannot support as many data flows as possible if “optimal paths” are calculated by the finding-shortest-path algorithm.

FIG. 1A illustrates an example of how a conventional LSRP typically functions. As FIG. 1A illustrates, the conventional LSRP always uses the current shortest path to select the next hop. With the assumption that all the link costs in the example in FIG. 1A are equal, the shortest paths from node s1 to node d1 and from node s2 to node d2 are both via node x3. This causes nodes x3 to become a bottleneck that limits overall network capacity.

In non-dynamic networks, a centralized approach such as traffic engineering provides a much higher network capacity than distributed routing protocols. Traffic measurements, topology collection and routing parameters configuration are performed externally from the routers, for example, by an operational network or a network management system. Based on a network-wide view and access of the network metrics, traffic engineering can bring more stability to the routing protocol, consume less bandwidth with less transmission overhead and incorporate more diverse performance constraints. In the situation of multiple shortest paths between a pair of routers, traffic engineering may offer a better load balancing by selecting the outgoing links to minimize the worst case traffic congestion at any node in the network.

However, such centralized optimization is not suitable to dynamic networks, such as Mobile Ad Hoc Networks. In these networks, cognitive routing may provide higher capacity than distributed routing protocols. In cognitive routing, the routers may adapt to the network environment through learning techniques and improve the route selection. For example, a Q-routing protocol based on the Q-learning framework offers a reinforcement-based routing protocol. In Q-routing, each network node has a separate logic controller that performs independent decision-making and policy selecting.

However, Q-routing protocols also have limitations. These limitations include the inability to fine tune routing policies especially at low network load level and the inability to learn new optimal policies under decreasing load conditions. While offering higher capacity, cognitive routing also takes time to learn the best paths. This results in worse performance than conventional distributed routing protocols at low load, for example, in terms of less path availability, longer convergence time and path delay.

FIG. 1B shows that the cognitive Q-routing may double the network load level as compared to shortest path routing when the network load level increases. But as network load decreases (between loads of 0.5 and 2), Q-routing performs worse than shortest path routing in terms of longer average delivery time. Improvements on Q-routing, such as predictive Q-routing, confidence Q-routing and backward exploration algorithms have been developed to address the problems associated with the original Q-routing. However, these protocols do not effectively address the increased delay associated with cognitive routing.

In summary, the prior work in distributed routing generally falls into two distinct categories. The first category of routing solutions focus on performance (e.g., providing less link delay through using least cost paths) at the cost of network capacity. The second category of routing solutions focus on optimizing network capacity at the expense of performance (e.g., longer link delay while exploring new topologies). Each category of approaches partially solves the problem. Furthermore, the second category of approaches focuses only on the less popular distance vector routing protocols. Thus, a holistic solution to the underlying problem, namely, the need for robust, high performance and high capacity routing mechanisms, is desired.

### SUMMARY OF THE INVENTION

Aspects of the invention include a routing method and system that combine a cognitive learning module with a link state protocol.

In one embodiment of the invention, a method is provided for obtaining routing paths in a communication network employing a link state protocol. The communication network includes a plurality of network nodes and a plurality of communication links connecting the plurality of network nodes. The method comprises receiving periodically, at one of the plurality of the network nodes, link state information of one or more of the plurality of communication links; storing received link state information for a predetermined period of time, wherein the stored link state information includes historical link state information; and determining, through a learning algorithm, routing paths to other network nodes of the plurality of network nodes based on the stored link state information.

In one example, calculating routing paths comprises calculating a shortest network path based on a Djikstra algorithm.

In another example, the link state information comprises path cost metrics describing link delay and queue lengths at the network nodes.

In a further example, wherein the learning algorithm is a Q-learning algorithm.

In one alternative, the method comprises comprising periodically sampling, through the learning algorithm, the stored link state information.

In another alternative, calculating routing paths further comprises calculating routing paths at a predetermined time interval.

In a further alternative, the predetermined time interval comprises a time corresponding to receipt of link state information.

In yet another example, the method comprises adapting with different learning ratios.

In yet another alternative, the method comprises discovering neighboring nodes by periodically sending a hello message to neighboring nodes within a predetermined hop count.

In another embodiment of the invention, a communication apparatus is provided in a communication network. The communication network includes a plurality of communication devices and a plurality of communication links connecting the plurality of communication devices. The communication apparatus connects to at least one of the plurality of communication devices over at least one of the communication links. The communication apparatus comprises a communication interface for periodically receiving link state information about one or more of the plurality of communication links from other communications devices, a processor in connection with the communication interface, a first memory coupled to the processor and containing a set of instructions executable by the processor. The set of instructions being executable to execute a link state protocol; store, in the first or a second memory, received link state information for a predetermined period of time, wherein the stored link state information includes current and historical link state information; and determine, through a learning algorithm, routing paths to the connected communication devices based on the stored link state information.

In one example, the communication apparatus comprises instructions to calculate shortest paths based on a Djikstra algorithm.

In another example, the link state information comprises path cost metrics describing respective link delay and queue lengths at the network nodes.

In a further example, the learning algorithm is a Q-learning algorithm.

In one alternative, the communication apparatus comprises instructions to periodically sample, through the learning algorithm, the stored link state information.

In another alternative, the routing paths are calculated on a predetermined basis regardless a link state database on said network node is updated or not.

In a further alternative, the predetermined basis is every time link state information is received.

In yet another example, the communication apparatus comprises instructions to adapt with different learning ratios.

In yet another alternative, the communication apparatus comprises instructions to discover neighbor nodes through periodically sending a hello message to neighbor nodes, wherein the neighbor nodes are within a predetermined hop count.

In a further embodiment of the invention, a network node is provided. The network node comprises a communication interface for periodically receiving link state information from a plurality of other network nodes, a memory storing executable instructions, and a processor operable to execute the instructions to store received link state information for a predetermined period of time and process the stored link state information to determine a routing path based on the stored link state information using an adaptive learning process. The stored link state information includes historical link state information.

In one example, the adaptive learning process comprises a Q-learning algorithm.

### BRIEF DESCRIPTION OF THE DRAWINGS

FIG. 1A illustratively depicts data flow in a conventional link state routing protocol.

FIG. 1B illustratively depicts a comparison between Q-routing and shortest-path routing.

FIGS. 2A-B illustratively depict system diagrams in accordance with an aspect of the invention.

FIG. 3 is a flow chart in accordance with an aspect of the invention.

FIG. 4 is a system diagram in accordance with an aspect of the invention.

FIG. 5 illustratively depicts data flow in accordance with aspects of the invention.

FIG. 6A illustratively depicts data flow in accordance with aspects of the invention.

FIG. 6B illustratively depicts a performance comparison of the networks shown in FIG. 6A.

FIG. 7 illustrates a sample network of devices in accordance with aspects of the invention.

FIG. 8 is a set of condition parameters used in a performance simulation of the network in FIG. 7.

FIGS. 9A-C compare performances of different routing protocols under the conditions of FIG. 8.

FIGS. 10A-C depict performance comparisons of different routing protocols using the conditions of FIG. 8.

FIG. 11 is another set of condition parameters used in a performance simulation of the network of FIG. 7.

FIGS. 12A-F depict performance comparisons of different routing protocols under the conditions of FIG. 11.

### DETAILED DESCRIPTION

Aspects, features and advantages of the system and method will be appreciated when considered with reference to the following description of exemplary embodiments and accompanying figures. The same reference numbers in different drawings may identify the same or similar elements. Furthermore, the following description is not limiting; the scope of the invention is defined by the appended claims and equivalents.

In accordance with aspects of the system and method, a network node in a communication network maintains a routing table that contains paths to all reachable destination nodes in the network. The network runs a link state routing protocol. The network node receives periodic disseminations of link state information from neighboring nodes in the network. The link state information includes neighboring node identity and link cost metrics. The network node calculates the initial routing paths based on the received link state information by using a link state routing algorithm. The network node then adapts the calculated paths based on both newly received link state information and past link state information through a reinforcement learning approach. It then selects a routing path to each destination node based on the adaptation and updates the routing table accordingly.

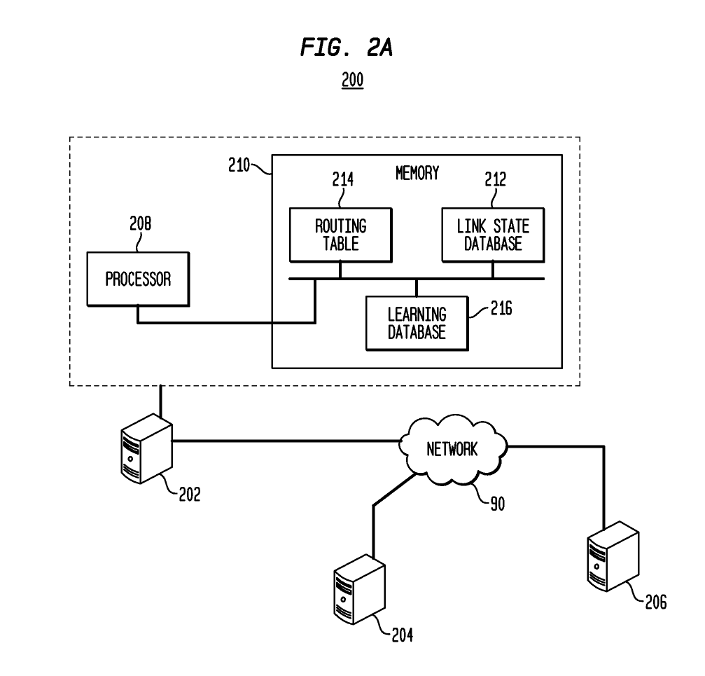

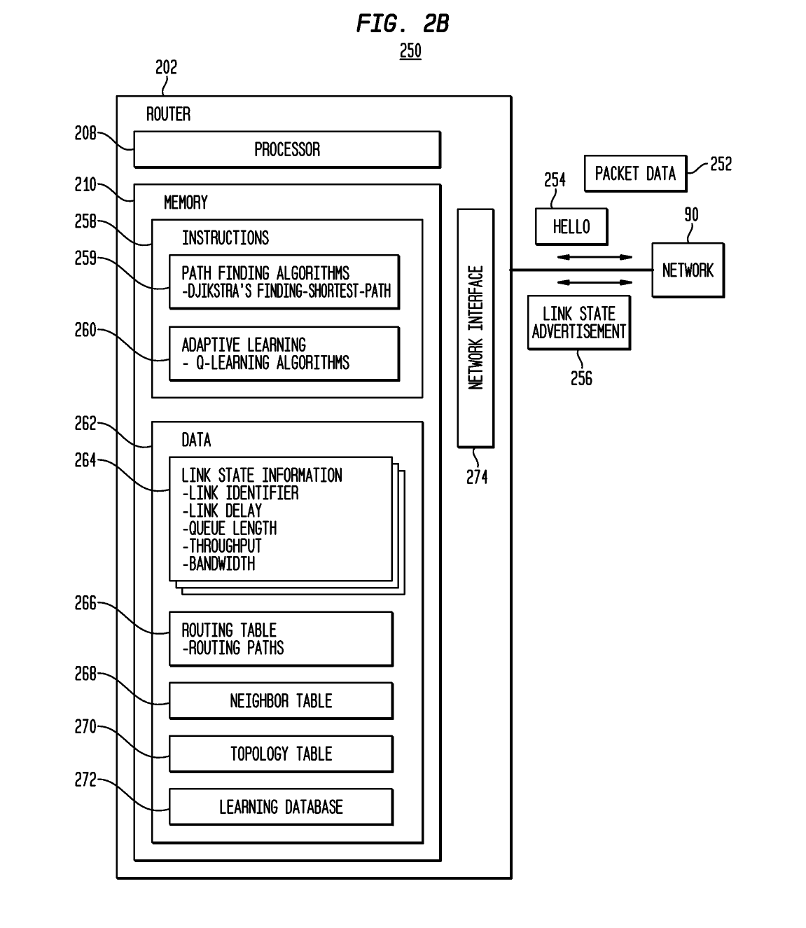

FIG. 2A illustrates a system 200 according to an aspect of the present invention. System 200 preferably comprises network 90 and routing nodes 202, 204 and 206. Routing nodes 202-206 may be configured for establishing and maintaining routes between each other. In one example, network 90 may be a distributed network and is configured to execute a link state routing protocol (LSRP), such as OSPF (Open Shortest Path First). In another example, it may be a mobile ad hoc network such as a MANET and the associated routing protocol is OLSR (Optimized Link State Routing Protocol).

As shown in FIG. 2A, a routing node, e.g., node or router 202, may be a computer or server that comprises a processor 208 and a memory 210. Databases to support various aspects of the routing functions may reside in the memory 210, such as link state database 212, routing table 214 and learning database 216. The processor 208 builds and distributes neighbor discovery and link state advertisement (also called topology control) packets, uses received routing packets from other nodes to update the link state database 212 and find paths based on predetermined algorithms and constructs the routing table 214. The link state database 212 preferably holds only the most up to date topology information; however in a cognitive routing approach, the learning database 216 may store historical information about the link state to support learning algorithms such as, for example, various selected reinforcement learning algorithms. The learning database 216 and any learning algorithms running on the processor are independently operating modules that may be added to or removed from any link state routing protocol.

FIG. 2B depicts a more detailed functional diagram of the router 202. As illustrated in FIG. 2B, the router 202 may be a server, a mobile computing device or any device with a similar architecture. Router 202 may contain a processor 208, memory 210 and other components typically present in general purpose computers. The router 202 may comprise a node of network 90 and may be capable of directly and indirectly communicating with other nodes of the network through network interface 274 (e.g., a network adapter). As illustrated, the router may send and receive various types of packet data 252, hello messages 254 and link state advertisement 256.

The memory 210 stores information accessible by processor 208, including instructions 258 and data 262 that may be executed or otherwise used by the processor 208. The memory 210 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 258 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. The instructions may contain various algorithms, including the path finding algorithms 259 used to find a best path from the router's network address to every possible destination node in the network 90. Adaptive learning (or reinforcement learning) algorithms 260, such as Q-learning algorithms) can also be instantiated in the instructions.

The processor 208 may be any conventional processor, such as processors from Intel Corporation or Advanced Micro Devices. Alternatively, the processor may be a dedicated device such as an ASIC. Although FIG. 2B functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor or computer will be understood to include references to a collection of processors or computers or memories that may or may not operate in parallel.

The data 262 may be retrieved, stored or modified by processor 208 in accordance with the instructions 258. For instance, although the system and method is not limited by any particular data structure, the data may be stored in computer registers, in a relational database as a table having a plurality of different fields and records, XML documents or flat files. The data may also be formatted in any computer-readable format, and may comprise any information sufficient to identify the relevant information, such as numbers, descriptive text, proprietary codes, references to data stored in other areas of the same memory or different memories (including other network locations) or information that is used by a function to calculate the relevant data.

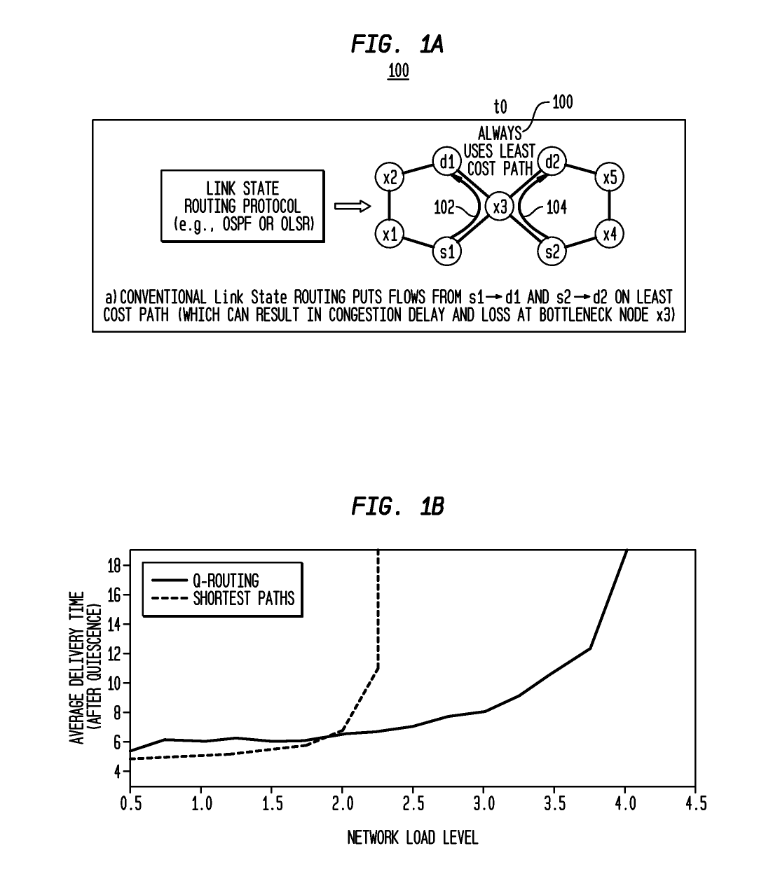

Data 262 may include the types of data structures described above in router 202 in FIGS. 1A or 2A. The router stores link state information 264 received from periodical link state information disseminations. The link state information describes network nodes disseminating the information and the link paths connected with the disseminating nodes.

Each routing server also maintains a routing table 266, which stores routing paths that are calculated by the path finding algorithms 259. Neighbor table 268 may be used to store a list of neighbor routing nodes within a predetermined hop count, e.g., 1-hop or 2-hop, to facilitate periodic neighbor discovery. A topology table 270 may be constructed from the link state information and represents the topology of the network domain in which the router belongs. A learning database 272 may be used to store historical link state data to support the learning algorithms on the router, such as adaptive learning algorithm 260.

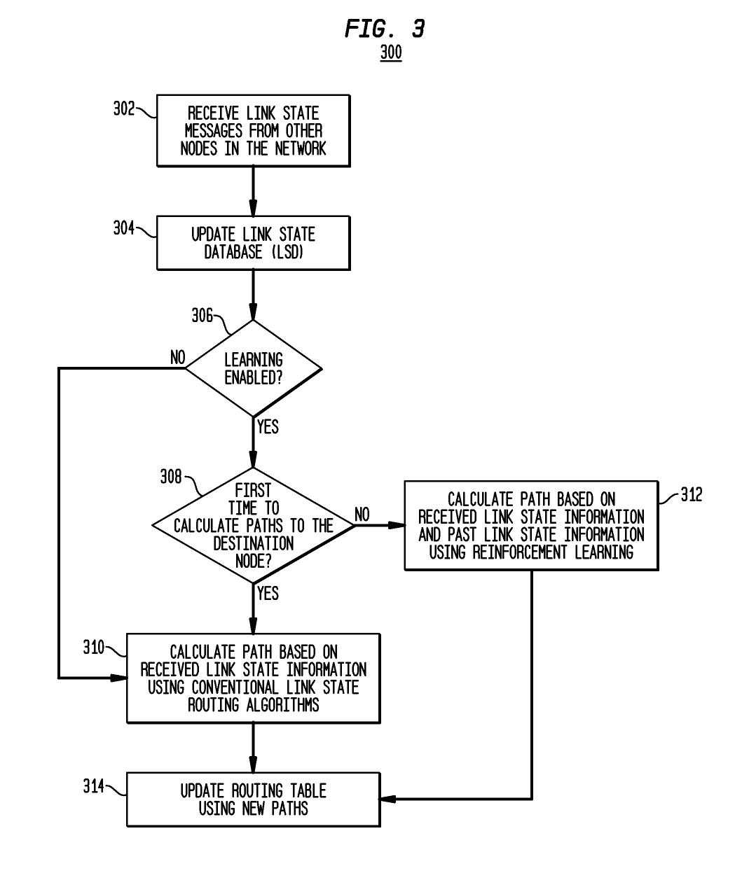

Operations in accordance with one or more aspects of the invention will now be described with reference to FIG. 3. It should be understood that the following operations do not have to be performed in the precise order described below. Rather, various operations can be handled in reverse order or simultaneously.

As shown in FIG. 3, the process preferably starts in block 302 with a network node's receipt of link state advertisements broadcasted from its neighboring nodes. The receiving node makes copies of the received link state packets and distributes link state advertisements to its neighboring nodes other than those from which the link state information were received. As shown at block 304, the receiving node updates its link state database with the received link state information.

In block 306, the receiving node determines whether a learning component is enabled or not. If the learning component is disabled, the hybrid routing system proceeds to block 310, where it calculates the paths based only on a link state routing algorithm. If the learning component is enabled, then the system decides, in block 308, if the relevant destination nodes need their routing paths to be initialized, i.e., a determination is made whether it is the first time that the receiving node is calculating a routing path for a particular destination node. This may happen, for example, during the initialization stage of a network domain. It may also happen when either the receiving node or the destination node or both are newly added to the network.

The system resorts to the conventional path selection algorithm in block 310 if it is calculating for the first time the path for the destination node in question. If at block 308 it is determined that the path is not a new path, the receiving node then proceeds to block 312, where it calculates paths leading to the possible destinations based on both the currently received link state information and the historic values of the respective link paths, which are captured through a cognitive learning process. Finally, in block 314, the routing table is updated with the newly calculated paths. Thus, in the hybrid routing system, past link state information, if available, is used in determining the current path for routing data to a destination point. That path is then added to the routing table for the receiving node.

Further, in a conventional link state protocol the paths in the routing table are not recalculated unless the information link state database is changed. In contrast, in a hybrid routing system, the recalculation is scheduled regardless the changes of the link state database, and may be done each time the database is updated or periodically. This allows capturing of link path changes or stability over time as part of the learning process.

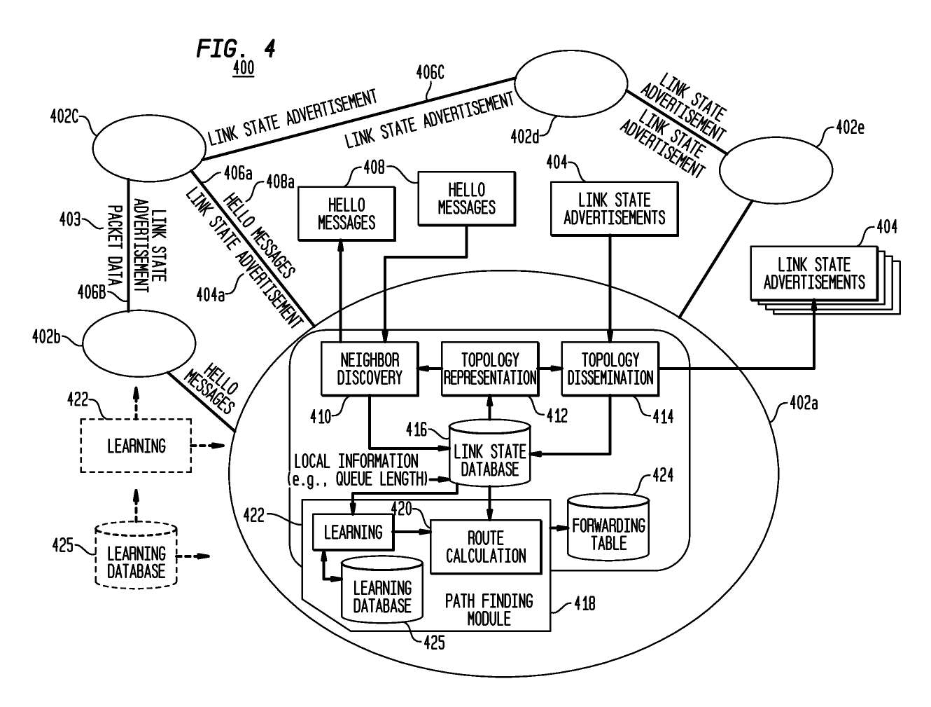

FIG. 4 illustrates a system 400 where routers 402a-e are configured for establishing and maintaining routes between each other in accordance with an aspect of the present invention. Each router 402a-e is configured to send and receive data packets, including link state advertisement messages 404, via links 406 to and from other connected routers.

As illustrated, each routing node executes a link state protocol and preferably comprise functional modules such as a neighbor discovery module 410, a topology representation module 412, a topology dissemination module 414, a link state database 416, a route calculation module 418, and a routing/forwarding table 424.

In system 400, each link state enabled routing node periodically builds and sends a Hello message 408 to its neighbors. More specifically, neighbor discovery module 410 on router 402a, based on the network topology map in 412, floods the Hello message to its one-hop neighbors who are listening on a well-known port. For example, in FIG. 4, node 402a may send a Hello message that is received by its one-hop nodes 402b, 402c and 402e. In another example, the neighboring nodes may include nodes within more than one hop, such as nodes 402d. The node that sent the Hello messages then builds a neighbor table based on the discovery. The neighbor information may be stored in the link state database 416 and used to help construct the local topology map.

Each routing node in system 400 may periodically obtain or perform a series of tests to obtain the cost associated with the link to each of its neighbors. For example, node 402c may measure the cost for link 406a leading to node 402a, the cost 402b for link 406b connecting node 402b, and the cost 402d for link 406c connecting node 402d. These costs may be measures of end-to-end delay, throughput, etc.

Link state advertisement messages 404 are also periodically built by each routing node and broadcasted to the neighboring nodes in system 400. For example, router 402a receives the link state advertisement message 404a sent from router 402c that describes the costs of link paths 406a-c. Each link state advertisement message 404 may include a link identifier that identifies a connected link 406, a link state field that may be used to identify the state of the link (e.g., active, idle, congested, unavailable, etc.), one or more cost metric field that contains the cost values of the connected link, and a link neighbor field that may be used to identify adjacent connected routing nodes.

The link state packet may also contain information identifying the initiating node, and a sequence number that monotonically increases each time the initiating node constructs a new link state packet. The link state advertisement may also include age parameters to prevent a packet wandering in the network for an indefinite period of time. Upon receiving link state advertisements, each node may further disseminate the packets to its neighbors so that all the routing nodes in a network rapidly obtain the most updated link state advertisements. The specific data structures of a link state advertisement may vary from different routing protocols and the details may be found in the standards for each protocol.

Each link state advertisement message describes the operating conditions of a link path 406 in terms of a cost metric associated with the link. The cost of a link path may be described by static cost metrics of the corresponding link path where the costs are measured at a given time. The cost may also be described by dynamic cost metrics of the corresponding link path where the link performance parameters may be obtained by multiple samplings over a prescribed period of time. The dynamic cost values may be further processed through various statistic processes before being included in the link state advertisement messages. For example, a statistic normalization process may be applied to the sampled cost values over the sample period to obtain a statistical mean or a median value of the sampled data.

Embodiments of the invention may utilize various dimensions of static and/or dynamic link cost metrics to express the link costs. For example, the cost metric may describe the costs in terms of available bandwidth, utilized bandwidth, link congestion, queue size at a router, link reliability, one-trip or round-trip transmission delay, etc.

Upon receiving the updated link state advertisements from other routing nodes, the router 402a updates its link state database 416 for each respective link path. Database 416 stores the most up to date information obtained from the link state advertisements 404 and Hello messages 408. This information forms a complete topology of network 412. The topology map represents all the network nodes in a weighted graph, such as the network graph shown in FIG. 1A. The weights are based on the most recently advertized link costs. The historic path costs with each respective link may be stored in a separate database 425.

Based on the current weighted graph of the whole network, the path finding module 418 may be configured to perform link state routing computations for determining optimal paths to transmit packet data to all possible destination nodes. The link state path selections may be performed based on a predetermined routing algorithm and the cost metrics in the link state database. Specific calculation algorithms may be based on, for example, Djikstra's shortest-path algorithm, where the routing node finds the path with least cost to each destination node. The optimal path selected based on cost may then be used to construct a routing table 424.

As shown in FIG. 4, the path finding module 418 further comprises a route calculation module 420, a learning module 422, and a learning database 425. The dashed-line learning components 425 and 422 indicates that these components are independent modules added on top of the link state routing protocol and may be enabled or disabled to allow each routing node to operate in two different routing modes. Preferably, the learning is switched on or off network wide.

In one embodiment of the invention, the learning component may be enabled to allow a node in the network to operate in hybrid mode. In hybrid mode, a node or router may determine path selection using reinforcement learning techniques. For example, in system 400, the learning component 422 in router 402a may execute a Q-learning process to select a path based not only on the instant path cost metrics received from the link state advertisements, but also on the historic cost metrics of the respective link paths.

As explained above, the learning resource component 422 may be flexibly combined with any specific link state routing protocol to support diverse applications and smooth migration to new routing protocols. For example, the component may be integrated with OSPF in wired networks and OSLR in wireless MANETs at the same time, or be integrated with any new link state routing protocols in the future. By separating the cognitive process from the standard protocol adopted by the routers, the component-based approach also allows a transparent understanding of the impact of a specific type of learning approach or algorithm. This may be achieved by studying the difference in the routing performances between the router performing under the standard mode (without learning component) and the hybrid mode (with the learning component). Furthermore, the component-based approach provides a framework for adding and combining different learning modules. Thus, when new learning approaches become available, the framework allows easy upgrade to new hybrid routing protocols.

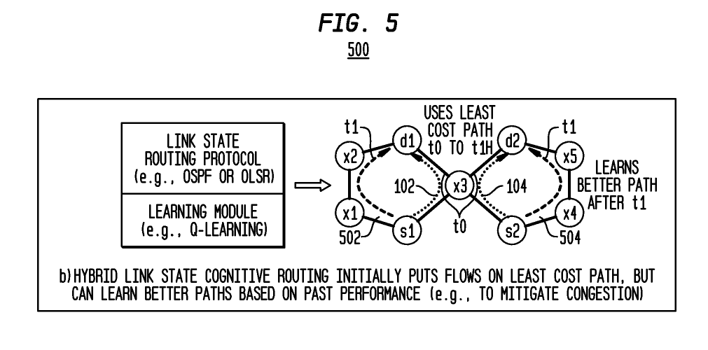

FIG. 5 illustrates an example 500 of how the hybrid link state cognitive routing system 400 may select a route in a network with the same topology as the network using conventional LSRP in FIG. 1. In general, learning may be applied with any types of link metrics. In example 500, delay based link costs may be used. Initially, at time to, the hybrid protocol may use the standard link state routing protocol to find the path with the least cost for data flow from node s1 to node d1 and from node s2 to node d2. Under the conventional link state protocol, the shorter paths 102 and 104 are selected as the optimal paths based on their lower instantaneous path costs. Data therefore travels along the selected paths 102 and 104. However, this may gradually result in queue size growth at node x3 which results in node x3 becoming a potential bottleneck. Congestion delay and data loss along paths 102 and 104 may thus gradually increase. Accordingly, the link costs of paths 102 and 104 may increase over the time while the link costs of paths 402 and 404 stay relatively low.

Source nodes s1 and s2 learn of changes in the link costs of paths 102 and 104 through the link state advertisements received from nodes d1, d2 and x3. The Q-learning process on the source nodes captures the knowledge of the delay in these paths and uses the knowledge to train the path selection accordingly. For example, in a Q-learning process, the value of Qₛ₁(d1, x3) supplies an indication of the estimation of the time necessary for data to reach destination node d1 from source node x1 through relay node x3. Generally, the Q value of Qₛ₁ may take account of the following transmission delay factors: journey time from x3 to d1 (t) and journey time from source node s1 to relay node x3 (s). In general, the transmission delays s and t may depend on factors such as the raw bandwidth, noise and interference with other transmitters. In addition, packets may be delayed in the queues at source node s1 (delay “p”) and relay node x3 (delay “q”). These queuing delays depend on the number of flows passing through the node and too many flows (congestion) will increase packet delay. At a given time, a new set of the above delay factors may be assembled from the most updated version of the link state advertisements. A learning ratio α (0<α<1) may then be applied to these factors and the old Q_{s1 old} value to obtain the new Qₛ₁ value:

Qₛ₁=α(t+q+s+p−Qₛ₁_{_{—}}_{old})

Over time, the impact of changes in delay along path 102 may gradually take over the previously selected path Qₛ₁_{_{—}}_{old}. Then, at time t1, path source node s1 starts to send the data packets along the paths 502 and 504 that have higher transmission cost (e.g., due to the longer paths) but lower average path costs over a predetermined period of time. The Q-learning process on node s1 may be optimized by various techniques such as confidence based dual reinforcement Q-learning. The learning ratio may be an empirical value or may be tunable.

The hybrid routing protocol offers an efficient routing solution by making use of the existing link state protocol. In example 500, the initial Q values, i.e., the starting routing paths, are obtained from the conventional link state routing algorithms, e.g., Djikstra's finding-shortest-path. In contrast, suboptimal initial routes and long optimization times result from Q-routing or other cognitive routing protocols that build the routing table through the cognitive process from the beginning. Furthermore, the hybrid routing system uses the existing messaging in the link state protocol (with possible small modifications if desired to carry additional link cost metrics (e.g., for OLSR to carry delay and not just hop count). By contrast, the Q-routing system defines its own messaging protocol. By retaining the feature of proactively calculating routing paths proactively in the link state protocol, the hybrid protocol offers a faster convergence and a more scalable solution than the reactive-based cognitive routing protocols.

In conventional link state routing protocols, routing paths are recalculated and routing tables are updated only when the link state database are changed, e.g., nodes are added/removed, path costs changed, etc. In hybrid routing system 400, with learning enabled, the path calculations may be rerun each time a new set of link state advertisements is received regardless whether the link state database is updated or not. Alternatively, the path recalculations may be performed on a periodical basis even if there is no change in the link state database.

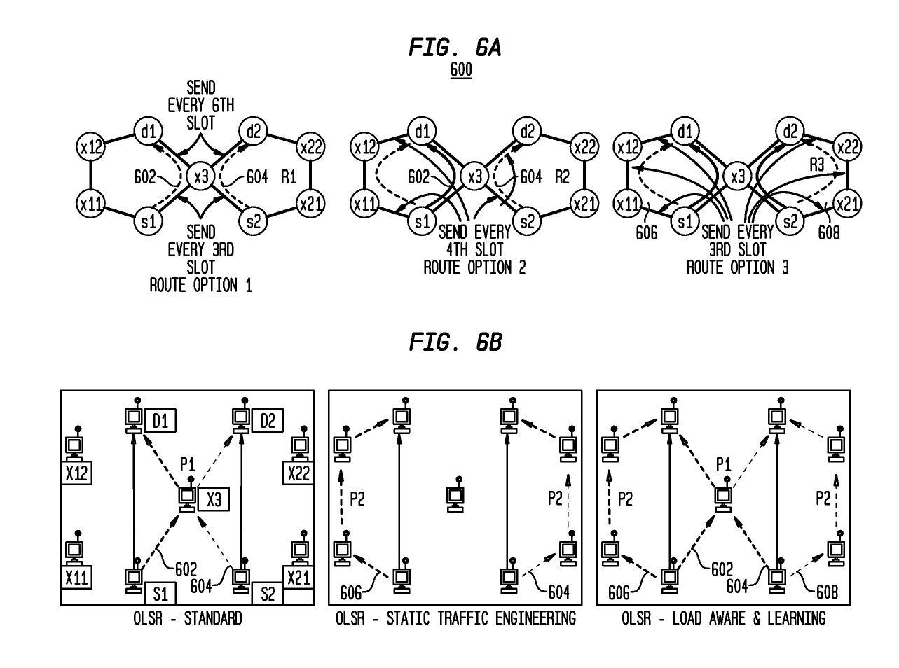

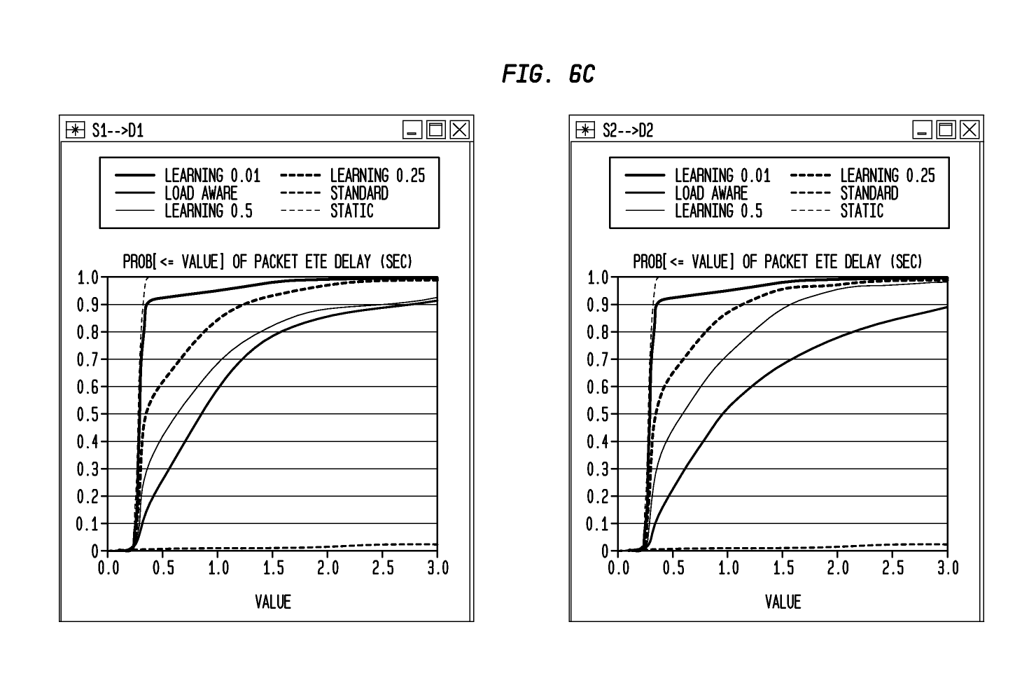

FIG. 6A shows a comparison of alternative paths that could be selected by routing protocols in the same nine-node network as in FIG. 5.

In scenario 600 the network adopts a distributed TDMA MAC algorithm as the transmission protocol. A constant bit rate flow (180 kbps) is scheduled between each source-destination node pair. The channel conditions are assumed to be ideal and the wireless link speed set to 1 Mbps.

In FIG. 6A, nodes s1 and s2 are source nodes and nodes d1 and d2 are destination nodes. Two paths are available from source node s1 to destination node d1: path 602 and path 604. Path 602 via node x3 associates with lower static costs and therefore is the shorter path of the two. Path 606 via nodes x11 and x12 associates with higher static costs and thus is the longer path of the two. Similarly, source node s2 has two alternative paths to reach destination node d2. The shorter path 604 goes via node x3 and the other path 608 goes via node x21 and x22.

Under route option 1, the standard routing protocol OLSR only considers path costs in terms of number of hops. Inner paths 602 and 604 are selected as the optimal routes. Both source nodes s1 and s2 select node x3 as their forwarding node. Over the time, this leads to congestion at node x3 and link delay along the paths 602 and 604. Furthermore, if every data packet occupies one TDMA data slot, TDMA MAC's fair scheduling policy allows data to be sent from node s1 and s2 every 3rd slot. If node x3 is under a full load condition with incoming data from the two nodes s1 and s2, x3 can forward data only every 6th slot. Accordingly, it takes an average of six slots for a packet to reach nodes d1 or d2 respectively from source nodes s1 or s2. Therefore, choosing the shortest path does not always give the best network performance in scenario 600.

Under route option 2, the outer path 606 is selected for the data flow from node s1 to node d1 and the inner path 604 is still used for the data flow from node s2 to node d2. Under this routing scheme, each data packet takes an average of four TDMA data slots traveling from the source to the destination. Under route option 3 where both outer paths 606 and 608 are selected to route the data flows from nodes s1 and s2, the network has the best performance where it takes an average of just three TDMA data slots per packet to travel from the source node to the destination node.

As shown in FIG. 6B, a centralized approach such as traffic engineering may be adopted to calculate the best paths for network flows. However, as explained before, although good for simple and static networks, traffic engineering is difficult to use in networks with dynamically changing traffic and topology such as a MANET. In these networks, a preferred solution is load aware routing, which we call OLSR-D, utilizing dynamic link cost metrics. For example, OLSR-D may be used to identify network congestion nodes or bottleneck points by measuring queue size, delivery time and channel acquisition delay etc. Each router attempts to route packets through less congested paths using the dynamically measured traffic conditions and current topology. However, load aware routing is known to suffer from route oscillations and instability in path selection, even in static network conditions. The oscillations result in high delay jitter, which can be highly undesirable to many network applications (e.g., voice over IP).

FIG. 6C shows the respective cumulative distribution function of end-to-end delay from node s1 to d1 and node s2 to d2 under different routing schemes. FIG. 6C illustrates the percentage of packet delay for the different routing protocols. The results show that the performance of each routing scheme in the network of FIG. 6A is: OLSR<OLSR-D<OLSR-Q.

In FIG. 6C, the standard OLSR presents an almost horizontal delay line indicating that the network is saturated and packets are not getting through. Each routing node selects the shortest path causing transmission queue build up at node x3, which further causes the network to saturate. OLSR-D is non-saturated with 80% of the packets experiencing less than 1.7 seconds of delay.

FIG. 6C also shows the end-to-end delay from three OLSR-Q implementations with different learning ratios (0.5, 0.25 and 0.01). The network performance with a learning rate at 0.01 gets close to the static traffic engineering approach and is significantly better than the OLSR-D performance. The static traffic engineering gives the best end-to-end delay performance with 80% of the packets experiencing less than 250 milliseconds of delay.

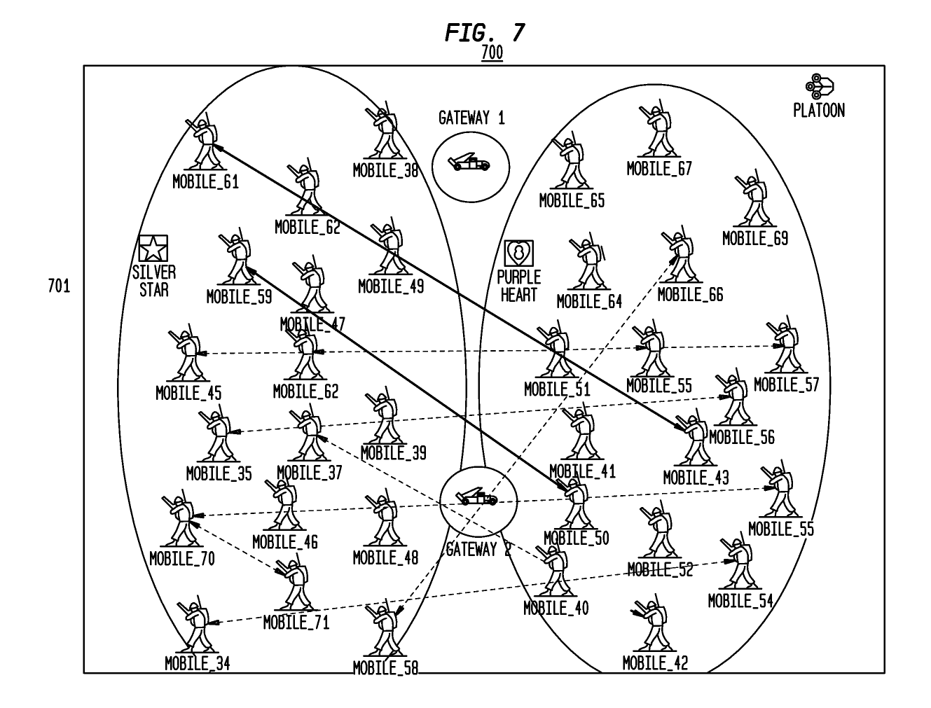

FIG. 7 illustrates a network simulation 700 of 36 nodes performed in OPNET. The simulation includes two squadrons of 17 soldiers (Silver Star and Purple Heart). The squadrons interconnect with each other by only two Gateways, Gateway 1 and Gateway 2. In scenario 700, ten bi-directional constant bit rate (CBR) traffic flows at 16 kpbs each flow between random soldier pairs.

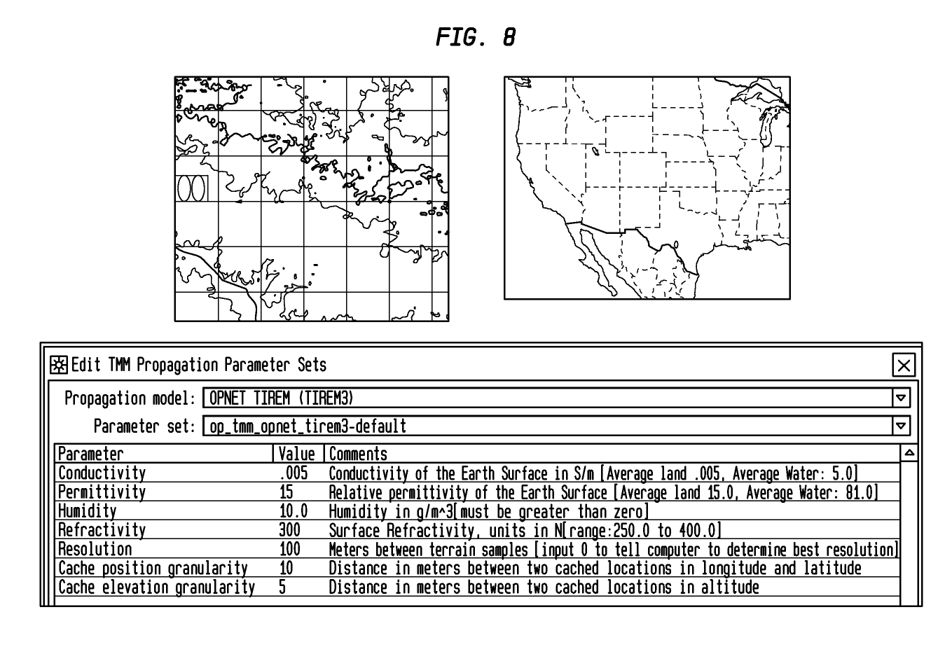

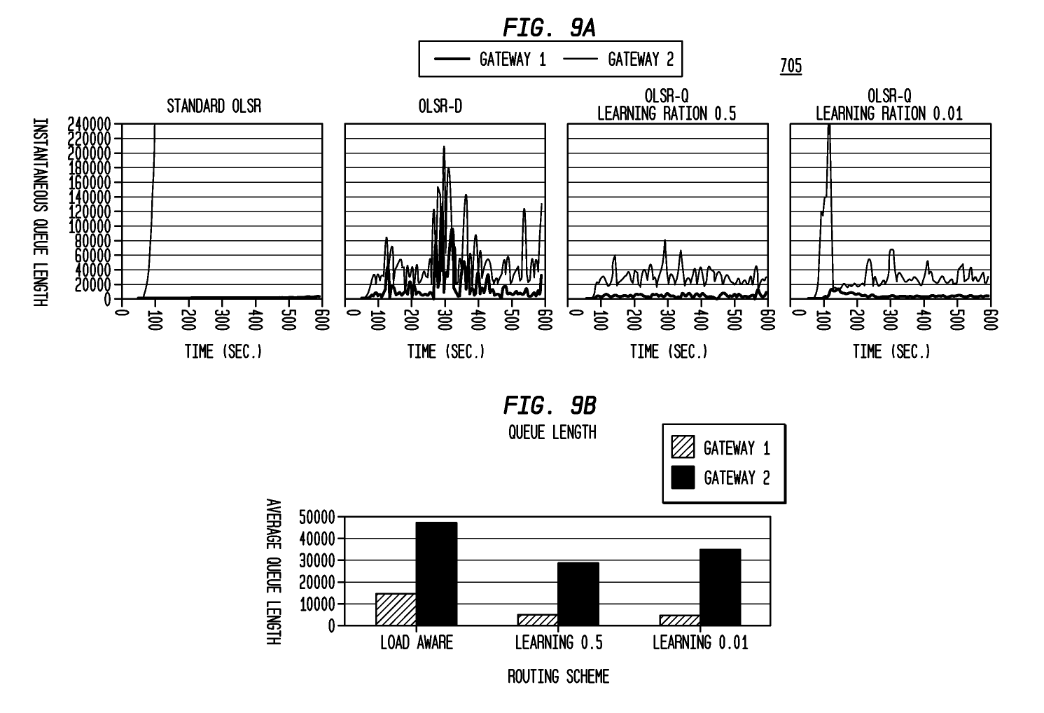

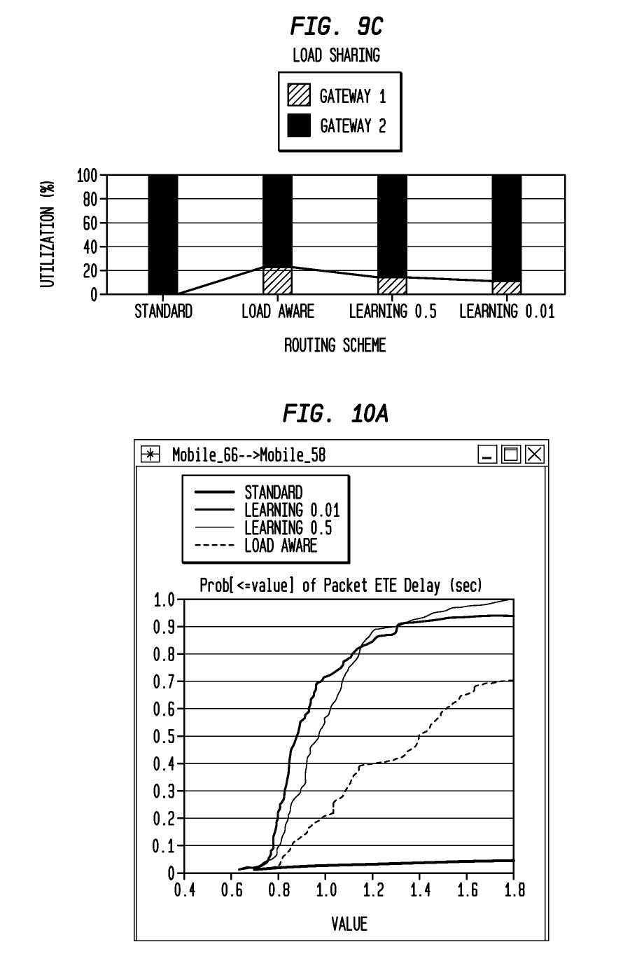

DTED 0 terrain data of a Texas geographical area (N29.5, W100.5) and TIREM3 propagation parameter set, as shown in FIG. 8 are used as static network parameters to model the channel conditions among the mobile nodes in scenario 700. FIGS. 9A-B show the queue sizes that result from simulating scenario 700 in OPNET with a static network topology and load. FIG. 9A illustrates instantaneous queue length (bit on y-axis) over time (seconds on x-axis) of Gateway 1 and Gateway 2. It shows that, using standard OLSR, most data between pairs of mobile nodes flow through Gateway 2. As a result, Gateway 2 becomes over utilized with ever increasing queue length and the network becomes saturated. Gateway 1 stays under-utilized with almost no queue building up.

Under OLSR-D, the load between Gateway 1 and Gateway 2 are shared. FIG. 9A shows that neither Gateway has an ever-increasing queue length, ensuring that the network is not saturated. However, queue lengths at Gateway 2 are high and experience lots of fluctuations. This is due the oscillations in the route, as a load-aware routing often results. Implementations of hybrid OLSR-Q at learning rates 0.01 and 0.5 both give better overall performance than standard OLSR and OLSR-D in terms of improved load sharing (as shown in FIG. 9B), reduced queue length (FIG. 9B) and dampened oscillations (FIG. 9A).

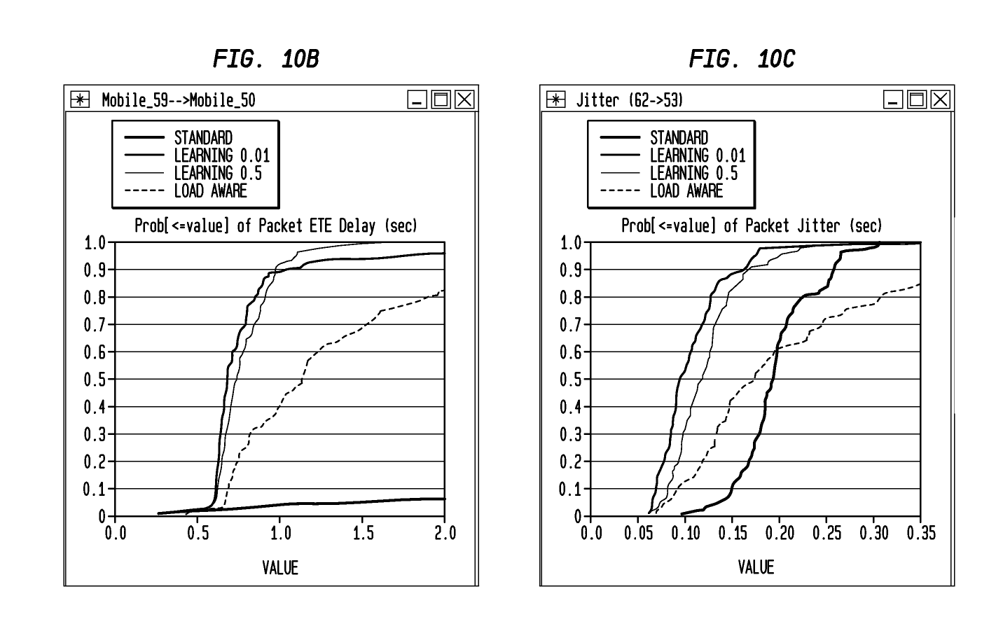

FIG. 9C shows average queue length under different routing schemes in scenario 700 with a static network topology. It shows that both OLSR-D and OLSR-Q increase the utilization of Gateway 1. FIGS. 10A-C show link performance between three pairs of nodes in scenario 700 with a static network topology. The charts in FIGS. 10A-C show that the load sharing and reduced queue sizes significantly lower the end-to-end delays. FIG. 10A and 10B are the cumulative distribution functions of end-to-end delays for data flows of node 66 to node 58 and node 59 to node 50. In FIG. 10A that shows the data flow from node 66 to node 58, 60% of packets had delay less than 1.5 seconds for OLSR-D and less than 1 second for OLSR-Q (with learning rate α=0.01 having a slightly lower delay than α=0.5). FIG. 10C, which illustrates the cumulative distribution functions of end-to-end delay jitter for the data flow between node 62 to node 53, shows that OLSR-Q also reduces delay jitter as compared to OLSR or OLSR-D.

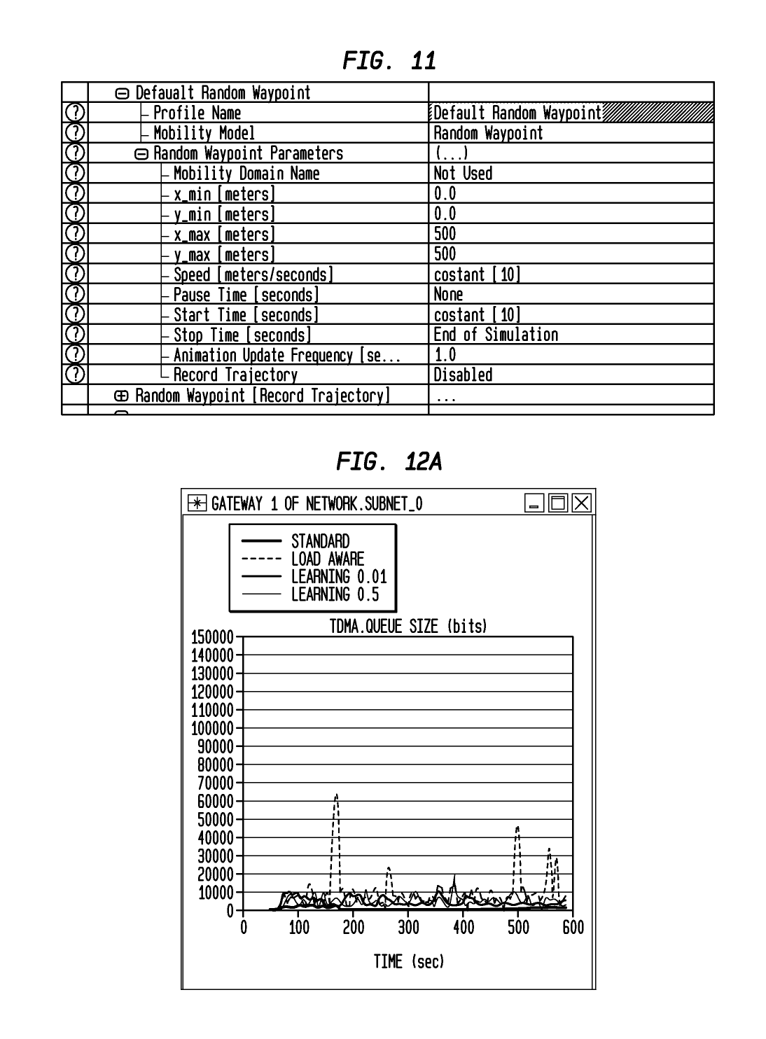

FIG. 11 is a set of dynamic condition parameters used to simulate network 700 in OPNET, where node mobility is added to all the nodes in scenario 700. The node mobility is defined by using OPNET's default parameters set for random mobility model.

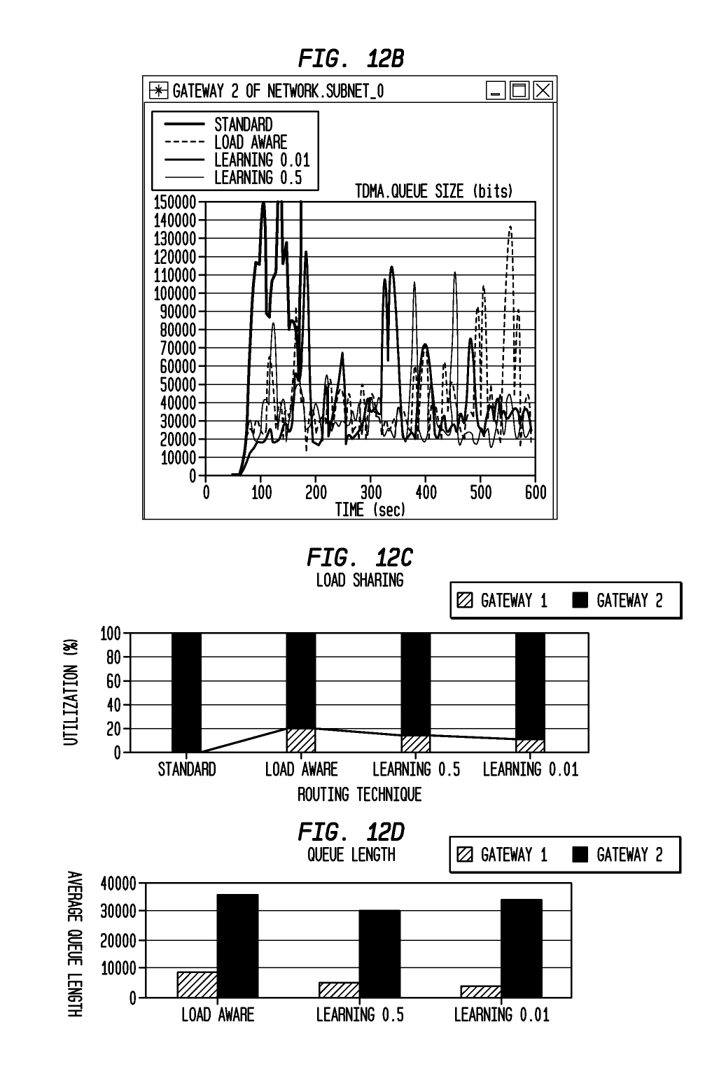

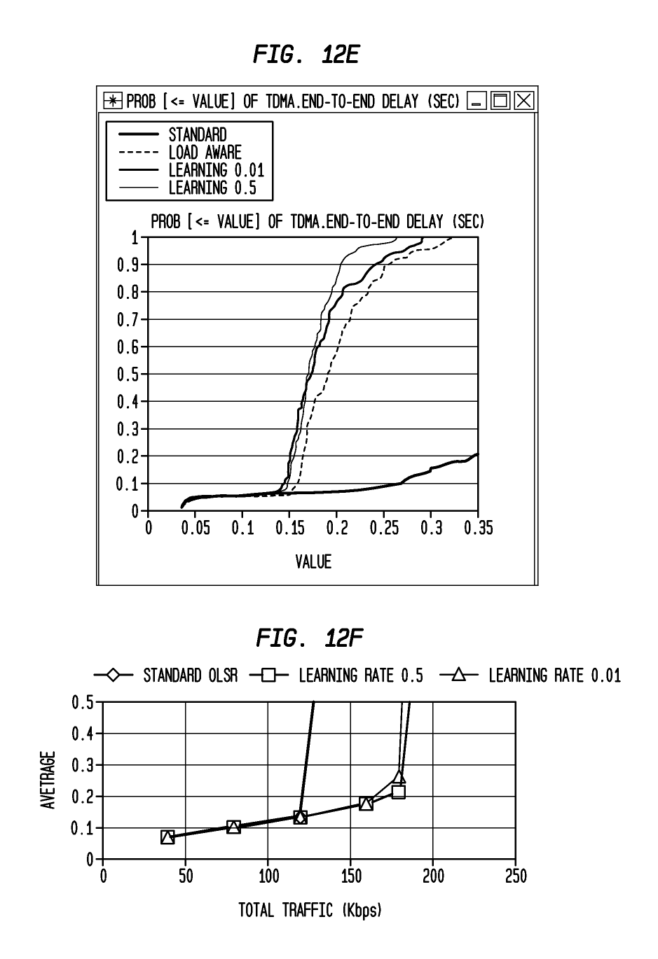

FIGS. 12A-B shows the dynamic network scenario 710 in terms of instantaneous queue length (bits on y-axis) over time (seconds on x-axis) of Gateway 1 and Gateway 2. FIGS. 12C-D shows the average load sharing and queue length for the different routing schemes. FIG. 12E shows the cumulative distribution functions of end-to-end delay. FIGS. 12A-E show scenario 700 producing similar results to those in a static network topology. Furthermore, in the dynamic network topology, OLSR-D and OLSR-Q now produce more similar performances. OlSR-Q with learning rate 0.5 now has the lowest delay.

FIG. 12F illustrates performance advantage of OLSR-Q over OLSR in the average delay against traffic load under different routing schemes. As illustrated, above a critical load of 120 kbps, OLSR delay increases rapidly as it goes beyond the capacity of the bottleneck links. In contrast, OLSR-Q reaches a 50% higher load (of 180 kbps) before the network saturates. FIG. 12F also shows that OLSR-Q has the same performance as OLSR at low loads, which is in marked contrast to existing cognitive routing approaches as illustrated in FIG. 1B.

It will be further understood that the sample values, types and configurations of data described and shown in the figures are for the purposes of illustration only. In that regard, systems and methods in accordance with aspects of the invention may be based on different link state routing protocols, and be used in different network architectures. The systems and methods may be provided and received at different times (e.g., via different servers or databases) and by different entities (e.g., some values may be pre-suggested or provided from different sources).

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

Unless expressly stated to the contrary, every feature in a given embodiment, alternative or example may be used in any other embodiment, alternative or example herein. For instance, any suitable cognitive learning algorithms may be employed in any configuration herein. Existing or future link state routing protocols may be used in any configuration herein. Any static or dynamic cost metric with parameters of network conditions may be used with any of the configurations herein.

1. A method for obtaining routing paths in a communication network including a plurality of network nodes and a plurality of communication links connecting the plurality of network nodes, the communication network employing a link state protocol, the method comprising:
receiving periodically, at one of the plurality of the network nodes, link state information of one or more of the plurality of communication links;
storing received link state information for a predetermined period of time, wherein the stored link state information includes historical link state information; and
determining, through a learning algorithm, routing paths to other network nodes of the plurality of network nodes based on the stored link state information.

2. The method of claim 1, wherein calculating routing paths comprises calculating a shortest network path based on a Djikstra algorithm.

3. The method of claim 1, wherein the link state information comprises path cost metrics describing link delay and queue lengths at the network nodes.

4. The method of claim 1, wherein the learning algorithm is a Q-learning algorithm.

5. The method of claim 1, further comprising periodically sampling, through the learning algorithm, the stored link state information.

6. The method of claim 5, wherein calculating routing paths further comprises
calculating routing paths at a predetermined time interval.

7. The method of claim 6, wherein the predetermined time interval comprises a time corresponding to receipt of link state information.

8. The method of claim 1, further comprising adapting with different learning ratios.

9. The method of claim. 1, further comprising discovering neighboring nodes by periodically sending a hello message to neighboring nodes within a predetermined hop count.

10. A communication apparatus in a communication network, the communication network including a plurality of communication devices and a plurality of communication links connecting the plurality of communication devices, the communication apparatus connecting to at least one of the plurality of communication devices over at least one of the communication links, the communication apparatus comprising:
a communication interface for periodically receiving link state information about one or more of the plurality of communication links from other communications devices;
a processor in connection with the communication interface;
a first memory coupled to the processor and containing a set of instructions executable by the processor; the set of instructions being executable to,
execute a link state protocol;
store, in the first or a second memory, received link state information for a predetermined period of time, wherein the stored link state information includes current and historical link state information; and
determine, through a learning algorithm, routing paths to the connected communication devices based on the stored link state information.

11. The apparatus of claim 10, further comprising instructions to calculate shortest paths based on a Djikstra algorithm.

12. The apparatus of claim 10, wherein the link state information comprises path cost metrics describing respective link delay and queue lengths at the network nodes.

13. The apparatus of claim 10, wherein the learning algorithm is a Q-learning algorithm.

14. The apparatus of claim 10, further comprising instructions to periodically sample, through the learning algorithm, the stored link state information.

15. The apparatus of claim 10, wherein the routing paths are calculated on a predetermined basis regardless a link state database on said network node is updated or not.

16. The apparatus of claim 15, wherein the predetermined basis is every time link state information is received.

17. The apparatus of claim 10, further comprising instructions to adapt with different learning ratios.

18. The apparatus of claim 10, further comprising instructions to discover neighbor nodes through periodically sending a hello message to neighbor nodes, wherein the neighbor nodes are within a predetermined hop count.

19. A network node comprising:
a communication interface for periodically receiving link state information from a plurality of other network nodes;
a memory storing executable instructions;
a processor operable to execute the instructions to store received link state information for a predetermined period of time, wherein the stored link state information includes historical link state information, and process the stored link state information to determine a routing path based on the stored link state information using an adaptive learning process.

20. The network node of claim 19, wherein the adaptive learning process comprises a Q-learning algorithm.
